(19) United States
(12) Patent Application Publication
(10) Pub. No.: US 2015/0028755 A1
(43) Pub. Date: Jan. 29, 2015

(54) LIGHT EMITTING DIODE ILLUMINATION DEVICE

(71) Applicant: ADVANCED OPTOELECTRONIC TECHNOLOGY, INC., Hsinchu Hsien (TW)

(72) Inventors: CHUNG-MIN CHANG, Hukou (TW); CHIEN-LIN CHANG-CHIEN, Hukou (TW); HSUEN-FENG HU, Hukou (TW); YA-TING WU, Hukou (TW); ZHENG-HUA YANG, Hsinchu (TW)

(21) Appl. No.: 14/310,543

(22) Filed: Jun. 20, 2014

(30) Foreign Application Priority Data
Jul. 26, 2013 (CN) 201310317794X

(51) Int. Cl. H05B 33/08

(52) U.S. Cl. CPC H05B 33/0827; H05B 33/083
USPC 315/192

(57) ABSTRACT

An LED illumination device includes an LED package and a switch electrically connecting the LED package. The LED package includes a first lamp group and a second lamp group installed in parallel. A direction of the current of the first lamp group is inverted to that of the second lamp group. Different contact parts of the switch respectively connect a power source to make the first lamp group and the second lamp group on or off respectively.

### FIELD

The present disclosure relates to LED (light emitting diode) lamps, and more particularly to an LED illumination device having adjustable light intensity.

### BACKGROUND

LEDs have many beneficial characteristics, including low electrical power consumption, low heat generation, long lifetime, small volume, good impact resistance, fast response and excellent stability. These characteristics have enabled the LEDs to be widely used as a light source in electrical appliances and electronic devices.

A conventional LED illumination device includes a plurality of LED packages and a light modulator electrically connecting the LED packages. The light modulator includes a filter, a frame supporting the filter and a rack guiding the frame sliding thereon. In use, the filter rotates relative to the frame and slides with the frame, and light emitted from the LED packages radiates to the filter and is filtered by the filter. Thus, the light intensity of the LED illumination device is adjusted.

### BRIEF DESCRIPTION OF THE DRAWINGS

FIG. 1 is a circuit diagram of an LED illumination device according to an exemplary embodiment of the present disclosure, wherein a first lamp group is connected.

FIG. 2 is a circuit diagram similar to FIG. 1, wherein a second lamp group is connected.

### DETAILED DESCRIPTION

Embodiments of an LED illumination device in accordance with the present disclosure will now be described in detail below and with reference to the drawings.

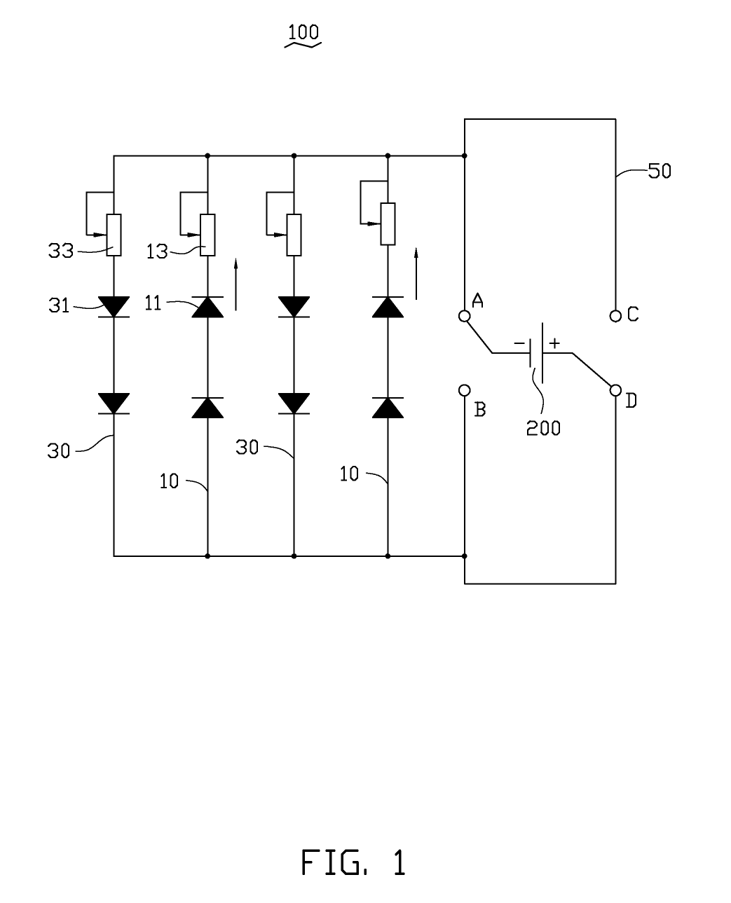

Referring to FIG. 1, an LED illumination device 100 of an exemplary embodiment is shown. The LED illumination device 100 includes an LED package and a switch 50 electrically connecting the LED package. The LED package includes a plurality of first lamp groups 10 and a plurality of second lamp groups 30 installed in parallel. In this embodiment, the LED package includes two first lamp groups 10 and two second lamp groups 30. Each first lamp group 10 includes two first LEDs 11 and a first slide rheostat 13 connected in series. A power of the first LED 11 is W1. The first slide rheostat 13 is operated to adjust the current values and a light intensity of the first lamp group 10. Each second lamp group 30 includes two second LEDs 31 and a second slide rheostat 33 connected in series. A power of the second LED 31 is W2. The second slide rheostat 33 is operated to adjust the current values and a light intensity of the second lamp group 30. A direction of the current of the first lamp group 10 is inverted to that of the second lamp group 30. The power W1 of the first LED 11 is larger than the power W2 of the second LED 31.

In this embodiment, the minimal light intensity of the first lamp group 10 is equal to or larger than 20% of the largest light intensity of the first lamp group 10. The largest light intensity of the second lamp group 30 is less than 20% of the largest light intensity of the first lamp group 10.

Referring to FIG. 1, when the LED illumination device 100 is operated, a contact part A and a contact part D of the switch 50 respectively connect a negative terminal and a positive terminal of a power source 200. In this state, the first lamp group 10 is connected, and the second lamp group 30 is disconnected. The first slide rheostat 13 is operated to adjust the light intensity of the first lamp group 10.

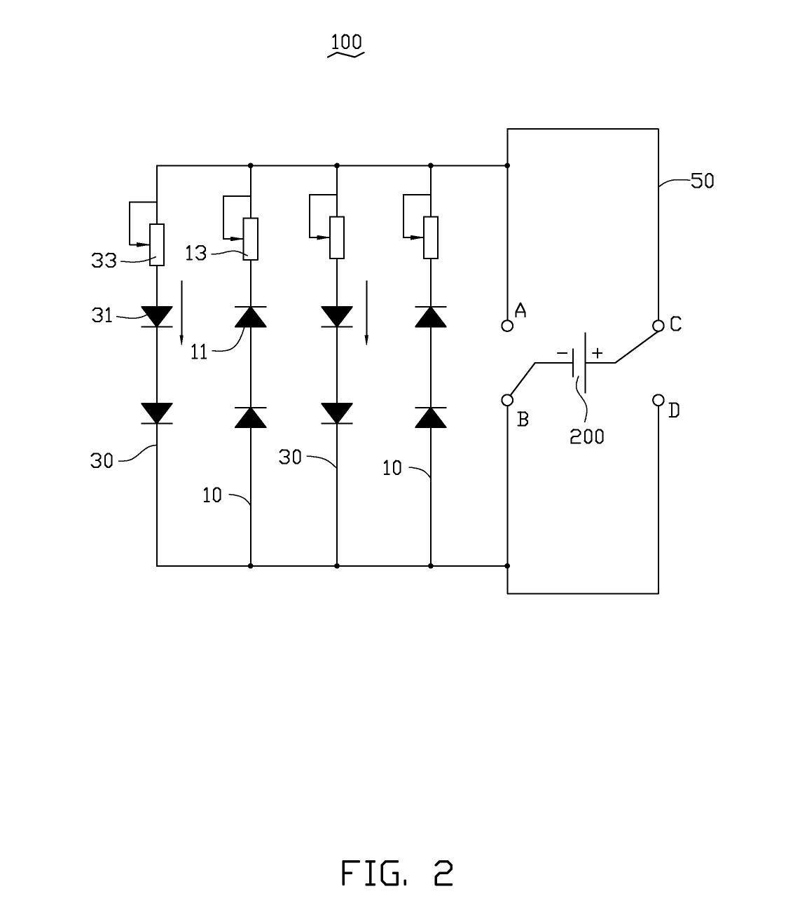

Referring to FIG. 2, when a contact part B and a contact part C of the switch 50 respectively connect the negative terminal and the positive terminal of the power source 200, the first lamp group 10 is disconnected and the second lamp group 30 is connected. The second slide rheostat 33 is operated to adjust the light intensity of the second lamp group 30.

In this embodiment, the switch 50 controls the first lamp group 10 or the second lamp group 30 on or off respectively to adjust the light intensity of the illumination device 100. Further, the first slide rheostat 13 and the second slide rheostat 33 can be operated to make the light intensity of the illumination device 100 vary in a large range.

The first lamp group 10 and the second lamp group 30 can have different color temperature. Each first LED 11 of the first lamp group 10 has a first color temperature, and each second LED 31 of the second lamp group 30 has a second color temperature. Alternatively, one of the first LED 11 has the first color temperature, the other first LED 11 of the first lamp group 10 has a third color temperature, and each second LED 31 of the second lamp group 30 has the second color temperature. In yet another alternative, each first LED 11 of the first lamp group 10 has the first color temperature, one of the second LED 31 has the second lamp group 30 has the second color temperature, and the other second LED 31 has a fourth color temperature.

It is understood, a package layer may envelope the package. The package layer is made of silicon or a mixture mixed by silicon and phosphor powder. It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed

What is claimed is:

1. An LED (light emitting diode) illumination device comprising:
an LED package, the LED package comprising a first lamp group and a second lamp group installed in parallel; and
a switch electrically connected to the LED package;
wherein a direction of a current of the first lamp group is inverted to that of the second lamp group, and different contact parts of the switch respectively connect to a power source to turn the first lamp group and the second lamp group on or off respectively.

2. The LED illumination device of claim 1, wherein the first lamp group comprises a plurality of first LEDs installed in series.

3. The LED illumination device of claim 2, wherein a first slide rheostat connects the first LEDs in series.

4. The LED illumination device of claim 2, wherein the second lamp group comprises a plurality of second LEDs installed in series.

5. The LED illumination device of claim 4, wherein a second slide rheostat connects the second LEDs in series.

6. The LED illumination device of claim 1, wherein the minimal light intensity of the first lamp group is equal to or larger than 20% of the largest light intensity of the first lamp group.

7. The LED illumination device of claim 6, wherein the largest light intensity of the second lamp group is less than 20% of the largest light intensity of the first lamp group.

8. The LED illumination device of claim 4, wherein each first LED of the first lamp group has a first color temperature, and each second LED of the second lamp group has a second color temperature

9. The LED illumination device of claim 4, wherein a part of the first LEDs has a first color temperature, and another first LEDs of the first lamp group has a third color temperature, and each second LED of the second lamp group has a second color temperature

10. The LED illumination device of claim 1, wherein each first LED of the first lamp group has a first color temperature, and a part of the second LED has a second lamp group has a second color temperature, and another second LED has a fourth color temperature.
